(19) United States
(12) Patent Application Publication
(10) Pub. No.: US 2006/0010393 A1
(43) Pub. Date: Jan. 12, 2006

(54) Apparatus and method for start of mobile phone supporting start mode using hard-wired code

(75) Inventors: Ji-Yun Jung, Seongnam-si (KR); Jung-Ho Park, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/175,388

(22) Filed: Jul. 7, 2005

(30) Foreign Application Priority Data
Jul. 7, 2004 (KR) 2004-52779

(51) Int. Cl. G06F 17/00

(52) U.S. Cl. 715/764

(57) ABSTRACT

Disclosed is a method for starting a terminal by supporting a hard-wired start mode. The method comprises the steps of: receiving an execution command of the hard-wired start mode; reading by a CPU of the terminal a start code obtained by hardware in a hard-wired area within a modem chip and executing the read start code; copying by the CPU of the terminal a loader achieved by hardware in the hard-wired area within the modem chip into a memory area; downloading a new start code and a new loader from an exterior host by means of the copied loader and storing the downloaded start code and loader; and replacing an internal start code and a loader of a flash area with the downloaded start code and loader. In the method, when an internal start code of a terminal has been broken, or broken codes or unexpected codes have been downloaded to a start area while downloading a program using serial ports, for example, it is possible to download the start code again through entering a hard-wired start mode.

### PRIORITY

This application claims the benefit under 35 U.S.C. § 119(a) to an application entitled “Apparatus and Method for Start of Mobile Phone supporting Start Mode using Hard-Wired Code” filed in the Korean Intellectual Property Office on Jul. 7, 2004 and assigned Serial No. 2004-52779, the entire contents of which are hereby incorporated by reference.

### BACKGROUND OF THE INVENTION

1. Field of the Invention

The present invention relates to a method for starting a mobile communication system, and more particularly to a method for starting a mobile terminal that supports a start mode by means of a hard-wired code.

2. Description of the Related Art

Generally, in a mobile terminal system provided with a Micro Processor Unit (MPU) or a microcomputer and a user interface, after the development of a program is completed, the program is recorded to a Read Only Memory (ROM) included in the system.

When codes stored in a ROM have not been broken, a mobile terminal can perform a normal start. In some instances, such a start code must be loaded from an external memory. In order to newly load the start code from the external memory, various serial ports are used. Herein, a start area may be broken due to an incomplete download caused by mistakes or errors during download of a new start program, or broken data or unexpected codes may be downloaded regardless of a successful download.

In these situations, it is impossible to download the start program using the serial ports. Accordingly, the new start program must be directly loaded to the memory of a mobile terminal by means of a Joint Test Access Group (JTAG) scan cable on a board after the mobile terminal is completely disassembled.

In addition, in order to use the JTAG scan cable, it is necessary to connect JTAG signals with a jumper. In this process, a soldering iron is used. Therefore, a terminal board may be broken from heat generated by the soldering iron or a user's carelessness. Even when a skilled user performs such work, much time is required.

### SUMMARY OF THE INVENTION

Accordingly, the present invention has been made to solve the above-mentioned problems occurring in the prior art, and it is an object of the present invention to provide a method and an apparatus for initializing or starting a terminal, which support a hard-wired start mode by means of an internal start code within a modem chip of a terminal such as a mobile terminal.

It is an object of the present invention to provide a method and an apparatus which can perform a start procedure through a hard-wired start mode regardless of whether an internal start code has been broken.

In order to accomplish the aforementioned object, according to one aspect of the present, there is provided a method for starting a terminal by supporting a hard-wired start mode. The method comprising the steps of: receiving an execution command of the hard-wired start mode; reading by a Communication Program Unit (CPU) of the terminal a start code achieved by hardware in a hard-wired area within a modem chip and executing the read start code; copying by the CPU of the terminal a loader achieved by hardware in the hard-wired area within the modem chip into a memory area; downloading a new start code and a new loader from an exterior host by means of the copied loader and storing the downloaded start code and loader; and replacing an internal start code and a loader of a flash area with the downloaded start code and loader.

In order to accomplish the aforementioned object, according to another aspect of the present, there is provided an apparatus for starting a terminal by supporting a hard-wired start mode, the apparatus comprising: a flash area for storing an internal start code and an internal loader; a memory area for copying the internal loader of the flash area or storing a new start code and a new loader downloaded from an exterior host, for performance of the start mode; and a modem chip comprising a hard-wired area established by obtaining the start code and the loader for the hard-wired start mode by hardware, the modem chip performing an initial start process by reading and executing the start-code of the hard-wired area when the hard-wired start mode is performed, the modem chip copying the loader of the hard-wired area into the memory area.

### BRIEF DESCRIPTION OF THE DRAWINGS

The above and other objects, features and advantages of the present invention will be more apparent from the following detailed description taken in

FIG. 1 is a flow diagram illustrating a start procedure of a terminal according to an embodiment of the present invention;

FIG. 2 is a diagram schematically illustrating a general start mode procedure of a terminal according to an embodiment of the present invention;

FIG. 3 is a diagram illustrating a hard-wired start mode procedure of a terminal according to an embodiment of the present invention; and

FIG. 4 is a block diagram illustrating a construction of a modem chip for supporting a hard-wired start mode according to an embodiment of the present invention.

Throughout the drawings, the same or similar elements, features and structures are represented by the same reference numerals.

### DETAILED DESCRIPTION OF THE EXEMPLARY EMBODIMENTS

Hereinafter, preferred embodiments according to the present invention will be described with reference to the accompanying drawings. In the following description of the present invention, a detailed description of known functions and configurations incorporated herein will be omitted for conciseness.

The present invention establishes a hard-wired code for starting a terminal within a modem chip of the terminal. If a start code of a flash area in the terminal is broken, it is impossible to download a program for start of the terminal from an external memory area. In this case, in order to achieve the start of the terminal regardless of whether the start code of the flash area in the terminal has been broken, a start code is stored in advance in the modem chip of the terminal. Then, when the start code in the terminal has been broken, the start procedure of the terminal is performed by means of the established hard-wired code in a hard-wired start mode. In order to perform the hard-wired start mode, the hard-wired start mode is selected using a specific pin on the exterior of the terminal. When an input of the specific pin is detected, the terminal performs the hard-wired start mode.

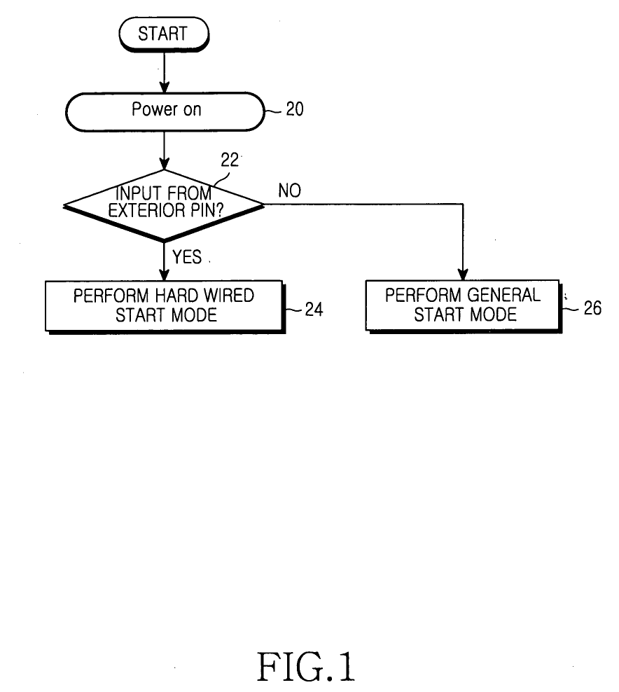

FIG. 1 is a flow diagram illustrating the start procedure of a terminal according to the present invention.

Referring to FIG. 1, in step 20, the terminal is powered on and initialized. In step 22, the terminal checks an input from an exterior pin and determines whether to perform either a hard-wired start mode or a general start mode. As a result of the determination, when the input from the exterior pin is detected, the terminal performs the hard-wired start mode in step 24. However, when the input from the exterior pin is not detected, the terminal performs the general start mode in step 26.

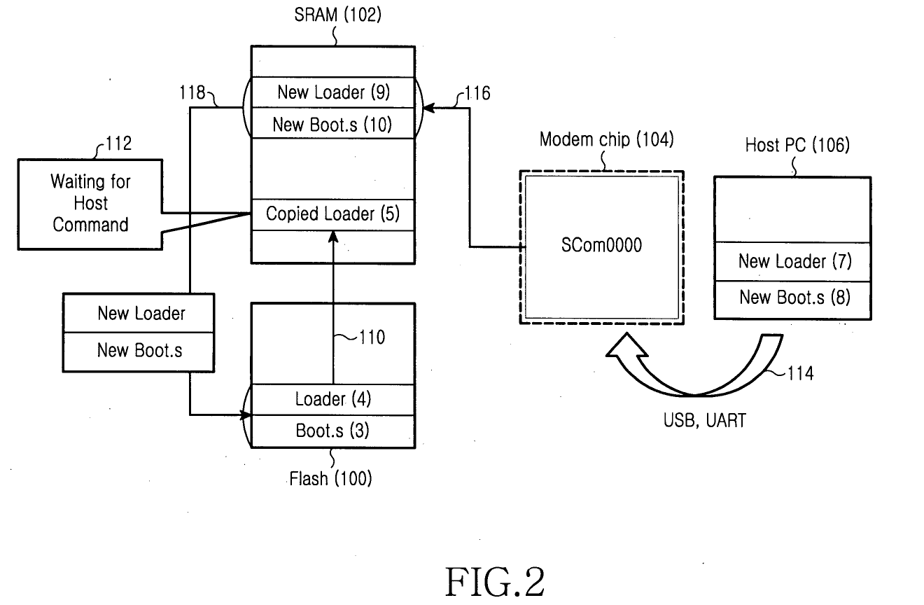

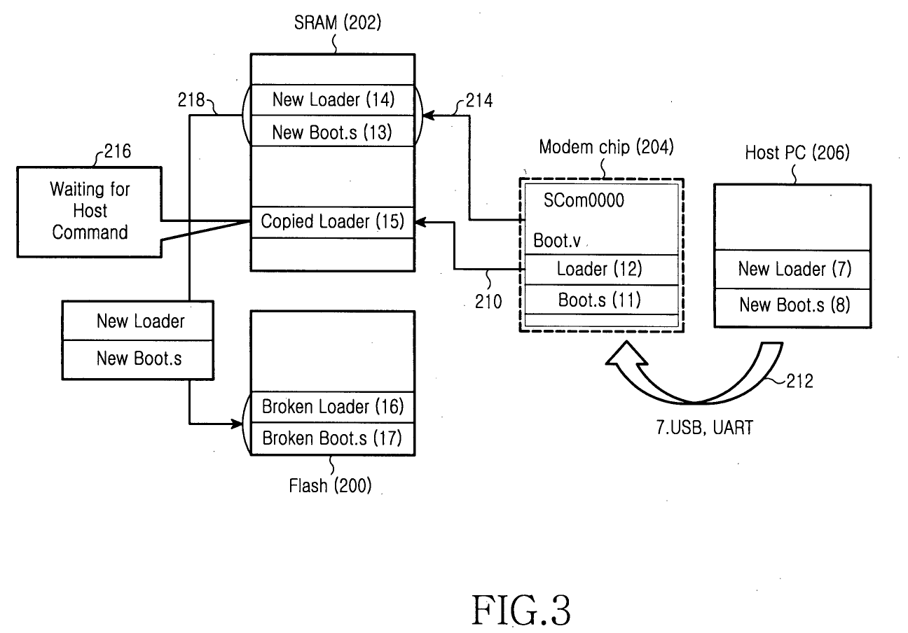

Hereinafter, the start modes of the terminal will be described in detail with reference to FIGS. 2 and 3.

FIG. 2 is a diagram schematically illustrating the general start mode procedure of the terminal.

As illustrated in FIG. 2, a memory of the terminal comprises a flash area 100 and a Static Random Access Memory (SRAM) area 102 for the start procedure.

Referring to FIG. 2, in a modem chip 104 of the terminal, a program counter indicates a start address of the flash area 100 and enters a start mode. A boot.s 3, which is an internal start code in the flash area 100, prepares the start procedure such as the establishment of a Communication Program Unit (CPU) bus controller, and so on, and copies a loader 4 of the flash area 100 into the SRAM area 102 (step 110).

After a CPU (not shown) in the terminal executes the copied loader 5, the CPU waits for a host command, as indicated at 112, while communicating with a host PC 106 by means of a specific protocol in order to download a start code including a new loader 7 and a new boot.s 8 from the host PC 106.

The host PC 106, which is connected to the terminal by means of a serial port such as a Universal Serial Bus (USB) and a Universal Asynchronous Receiver Transmitter (UART), communicates with the modem chip 104 of the terminal and transfers the new start code including the new loader 7 and the new boot.s 8 to the modem chip 104, as indicated at 114. The modem chip 104 stores the new loader 7 and the new boot.s 8 in the SRAM area 102, as indicated at 116.

A new loader 9 and a new boot.s 10 downloaded in the SRAM area 102 substitute for the loader 4 and the boot.s 3 of the flash area 100 before being stored, as indicated at 118.

When the terminal detects an input for entering a hard-wired start mode, the terminal performs the hard-wired start mode according to FIG. 3 which will be described below. In the hard-wired start mode, the terminal does not copy the loader stored in the flash area for start. Accordingly, the loader may be used when the start code stored in the flash area of the terminal has been broken or an erroneous start code and program have been downloaded to the start area from the exterior. In the present invention, the start code for start of the terminal is obtained via hardware, so that it is possible to perform the start procedure of the terminal in the same way as the case executing the start code, even without direct connection with the memory.

FIG. 3 is a diagram illustrating a hard-wired start mode procedure of a terminal according to the present invention.

Referring to FIG. 3, the terminal comprises a memory having a flash area 200 and a SRAM area 202, and a modem chip 204. In addition, the modem chip 204 comprises a hard-wired area for storing a boot.s 11 and a loader 12 included in a start code. When a broken boot.s 17 and a broken loader 16, which are broken codes not available for performing a normal start mode, are stored in the flash area 200, a user or developer sets a hard-wired mode by using an external input pin. Then, the CPU of the terminal reads the boot.s 11 and the loader 12, which are used for performing a start procedure, with a code achieved by hardware.

After entering a hard-wired start mode, the boot.s 11 of the modem chip 204 executed by a CPU prepares the start procedure. That is, the boot.s 11 copies the loader 12 into the SRAM area 202 instead of the broken loader 16 stored in the flash area 200, as indicated at 210.

If the new loader 15 copied into the SRAM area 202 is executed, the modem chip 204 starts to download a loader 7 and a boot.s 8 included in a new start mode from a host PC 206 by means of a USB, a UART, and so on, as indicated at 212.

The newly downloaded loader 13 and boot.s 14 are stored in the SRAM area 202 (214), the loader 13 and the boot.s 14 substitute for the internal start code of the flash area 200 before being stored. As a result, the terminal having the broken internal start code can normally perform the start procedure.

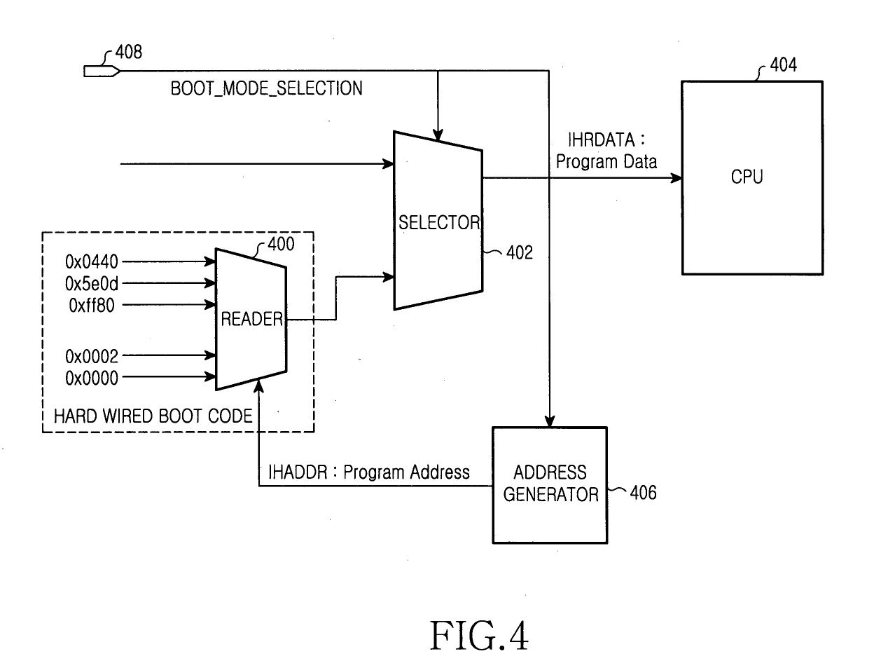

FIG. 4 is a block diagram illustrating the construction of the modem chip for supporting the hard-wired start mode according to the present invention.

Referring to FIG. 4, the modem chip comprises an address generator 406 for generating a hard-wired start mode address, a reader 400 for reading the start code of a corresponding hard-wired area according to the address, a selector 402 for selecting the start code of a flash area or a hard-wired area according to the start mode, a CPU 404 for performing a start procedure according to program codes input from the selector 402, and an input pin 408 for detecting an execution command of the hard-wired start mode through an external input.

The input pin 408 is connected to the selector 402 and the address generator 406 and detects an external input. When the external input is detected by the input pin 408, the address generator 406 transfers the start address of the hard-wired area to the reader 400. The reader 400 receives the hard-wired start address and reads a hard-wired start code.

When the execution command of the hard-wired start mode is detected by the input pin 408, the selector 402 selects the hard-wired start code read by the reader 400 and transmits the selected hard-wired start code to the CPU 404. However, when the external input is not detected by the input pin 408, the selector 402 selects an internal start code of the flash area and transmits the selected internal start code to the CPU 404.

The CPU 404 controls operations of the reader 400, the selector 402 and the input pin 408, and performs a corresponding start procedure according to the start code transmitted from the selector 402.

In the present invention as described above in detail, a number of advantages are realized.

When an internal start code of a terminal has been broken, and a start area has been broken due to an incomplete download caused by mistakes or errors during download of a new start program through various serial ports, or broken data or unexpected codes has been downloaded regardless of a successful download, it is possible to download the start code again through entering a hard-wired start mode without disassembling the terminal.

Further, the present invention achieves the flexibility of a start code through a hard-wired start mode for supporting a case where an internal start code has been broken, thereby reducing the loss of a terminal and improving the customers' satisfaction for service.

While the present invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for starting a terminal by supporting a hard-wired start mode, the method comprising the steps of:
receiving an execution command for the hard-wired start mode;
reading by a Communication Program Unit (CPU) of the terminal a start code obtained via hardware in a hard-wired area within a modem chip and executing the read start code;
copying by the CPU of the terminal a loader achieved by hardware in the hard-wired area within the modem chip into a memory area;
downloading a new start code and a new loader from an exterior host by means of the copied loader and storing the downloaded start code and loader; and
replacing an internal start code and a loader of a flash area with the downloaded start code and loader.

2. The method as claimed in claim 1, further comprising the steps of:
when the execution command of the hard-wired start mode does not exist, reading the internal start code stored in the flash area and executing the read start code;
copying the loader stored in the flash area into the memory area;
downloading the new start code and the new loader from the exterior host by means of the copied loader and storing the downloaded start code and loader; and
replacing the internal start code and the loader of the flash area with the downloaded start code and loader.

3. The method as claimed in claim 1, wherein the hard-wired start mode is performed when the internal start code and the loader stored in the flash area have been broken or a start code area has been broken due to an error having occurred in downloading the new start code and the new loader from the exterior host.

4. An apparatus for starting a terminal by supporting a hard-wired start mode, the apparatus comprising:
a flash area for storing an internal start code and an internal loader;
a memory area for copying the internal loader of the flash area or storing a new start code and a new loader downloaded from an exterior host, for performance of the start mode; and
a modem chip having a hard-wired area established by obtaining the start code and the loader for the hard-wired start mode by hardware, the modem chip performing an initial start process by reading and executing the start code of the hard-wired area when the hard-wired start mode is performed, the modem chip copying the loader of the hard-wired area into the memory area.

5. The apparatus as claimed in claim 4, wherein the modem chip comprises:
an input unit for detecting an execution command of the hard-wired start mode;
an address generator for generating a hard-wired start mode address;
a reader for reading the start code and the loader of the hard-wired area according to the address;
a selector for selecting the start code according to an input of the input unit; and
a Communication Program Unit (CPU) for performing a corresponding start procedure according to program codes selected by the selector.

6. The apparatus as claimed in claim 5, wherein the selector selects a hard-wired code read by the reader when an input from the input unit exists, and selects the internal start code of the flash area and transmits the select internal start code to the CPU when the input from the input unit does not exist.

7. The apparatus as claimed in claim 4, wherein the hard-wired start mode is performed when the internal start code and the loader stored in the flash area have been broken or a start code area has been broken due to an error having occurred in downloading the new start code and the new loader from the exterior host.

8. Program code embodied on a computer-readable medium for starting a terminal by supporting a hard-wired start mode, the program code comprising:
a first set of instructions for receiving an execution command for the hard-wired start mode;
a second set of instructions for reading by a Communication Program Unit (CPU) of the terminal a start code obtained via hardware in a hard-wired area within a modem chip and executing the read start code;
a third set of instructions for copying by the CPU of the terminal a loader achieved by hardware in the hard-wired area within the modem chip into a memory area;
a fourth set of instructions for downloading a new start code and a new loader from an exterior host by means of the copied loader and storing the downloaded start code and loader; and
a fifth set of instructions for replacing an internal start code and a loader of a flash area with the downloaded start code and loader.

9. The program code as claimed in claim 8, further comprising, when the execution command of the hard-wired start mode does not exist:
a sixth set of instructions for reading the internal start code stored in the flash area and executing the read start code;
a seventh set of instructions for copying the loader stored in the flash area into the memory area;
an eighth set of instructions for downloading the new start code and the new loader from the exterior host by means of the copied loader and storing the downloaded start code and loader; and
a ninth set of instructions for replacing the internal start code and the loader of the flash area with the downloaded start code and loader.

10. The program code as claimed in claim 1, wherein the program code further comprises instructions to perform the hard-wired start mode when the internal start code and the loader stored in the flash area have been broken, or a start code area has been broken due to an error having occurred in downloading the new start code and the new loader from the exterior host.
